(19) United States
(12) Patent Application Publication
(10) Pub. No.: US 2026/0302425 A1
(43) Pub. Date: Oct. 1, 2026

(54) CELL INTERSPACE COOLING FOR PRISMATIC CELLS WITH IMMERSION COOLING

(71) Applicant: Webasto Roof & Components SE, Stockdorf (DE)

(72) Inventors: Fritz Wegener, Stockdorf (DE); Salomé Ladeira, Stockdorf (DE)

(21) Appl. No.: 19/633,266

(22) Filed: Mar. 30, 2026

(30) Foreign Application Priority Data
Mar. 31, 2025 (DE) 102025112592.9

(51) Int. Cl. H01M 10/6568; H01M 10/613; H01M 10/625

(52) U.S. Cl. CPC H01M 10/6568; H01M 10/613; H01M 10/625; H01M 2220/20

(57) ABSTRACT

A battery module is disclosed, comprising a first prismatic battery cell, a second prismatic battery cell and a profile, where a cross section of the profile in a non-loaded state of the profile comprises a repeated sequence of a first essentially planar segment for contact on the first battery cell, a first elastic segment, which is connected to the first essentially planar segment, a second essentially planar segment for contact on the second battery cell, which is connected to the first elastic segment, and a second elastic segment, which is connected to the second essentially planar segment, and where the profile is arranged in an installed state between the first and the second prismatic battery cell.

### CROSS-REFERENCE TO RELATED APPLICATION

This application claims priority to German Application No. DE 102025112592.9 filed on Mar. 31, 2025, which is incorporated herein by reference in its entirety for all purposes.

### Technical Filed

The present disclosure relates to battery modules. Moreover, the present disclosure relates to battery modules with cell interspace cooling.

### Background

In electrically driven vehicles, traction energy for supplying the electrical vehicle drive is provided by a battery system. The battery system typically comprises a plurality of battery modules. Each battery module generally comprises a plurality of battery cells.

Waste heat arises in the cells during the charging and discharging of the battery cells. The waste heat is a limiting factor for the maximum power and the safe operation of the battery system, for example for the possible charging currents. One approach for dissipating the waste heat is the use of fluid cooling, for example immersion cooling. A fluid which is weakly electrically conductive or electrically nonconductive is provided around the battery cells or battery modules and this fluid absorbs the heat and removes it.

Furthermore, expansion and contraction of the battery cells during the charging and discharging procedures occur when using the vehicle batteries, for example if lithium-ion batteries are used. Expansion is also referred to as swelling. The battery cells do not necessarily swell uniformly, so that individual swollen areas can occur on the outer surface of a battery cell. So-called swelling pads are typically used between prismatic battery cells between the battery cells of a battery module. However, these obstruct the flow of coolant air or coolant liquid between the prismatic cells, so that prismatic battery cells are typically cooled from their lower side, which can result in a temperature gradient over the height of the battery cell.

US2011/189525A1 discloses a heat exchanger structure for use in a battery unit, which comprises a first battery stack having multiple battery cells and a second battery stack having multiple battery cells. The heat exchanger structure is arranged between opposing surfaces of the first battery stack and the second battery stack and defines one or more fluid flow channels, wherein the heat exchanger structure is dimensioned so that it contracts under expansion of the first and second battery stacks and expands under subsequent contraction of the first and second battery stacks.

DE102022106000A1 discloses a battery, which comprises at least one set of power storage cells having mutually opposing flat sides separated from one another by a gap; multiple partitions in each gap, which bound multiple channels for the circulation of a thermal carrier fluid between them; and a circuit for cooling the power storage cells, which comprises multiple distribution channels formed between the bottom of the battery and the lower sides of the power storage cells. The distribution channels distribute the thermal carrier fluid in the circulation channels of all gaps.

FR3135566A1 discloses a battery and an associated production method. The battery comprises: at least one unit of power storage cells oriented in a main direction, wherein two power storage cells adjacent in the orientation have mutually opposing large surfaces which are separated from one another by an intermediate space; a partition structure, which bounds at least one circulation channel for a thermal carrier fluid that is in contact with each large surface that bounds the intermediate space, in each intermediate space; wherein at least one of the partition structures is a compressible sandwich element.

DE102016207837A1 discloses an energy storage apparatus. The energy storage apparatus contains an energy storage device and an adjacent element in the neighbourhood of the energy storage device, wherein the energy storage device comprises a housing body for accommodating an electrode arrangement, wherein the housing body has a body part including an opening on at least one first end of the body part in a first direction, and comprises a cover for closing the opening, wherein the body part has a thick-walled part, which is formed at the first end and/or a second end of the body part in the first direction, and a thin-walled part, which is thinner than the thick-walled part, wherein the adjacent element has a pair of seal parts, which are arranged at a distance in the first direction, and wherein each of the seal parts is in contact with the thin-walled part.

DE102018108962A1 discloses a battery cell module for the energy supply of an electric motor for driving a motor vehicle, having at least one film cell and at least one cooling unit, which is arranged at least in some sections on the at least one film cell for cooling the at least one film cell, wherein the at least one cooling unit has at least one elastically deformable pre-tensioning means, which applies a predefined pre-tensioning force to the at least one film cell, and wherein, in the at least one cooling unit, at least one fluid guiding section is formed for guiding a coolant fluid at least in some sections along the at least one pre-tensioning means.

DE102022102513A1 discloses a battery module for a motor vehicle. The battery module has a battery cell stack made up of multiple battery cells stacked in a stack direction. Furthermore, the battery module has a housing in which the battery cell stack is accommodated. Furthermore, the battery module has a profiled equalizing element, which is arranged between a first battery cell of the battery cell stack and the housing or between a first battery cell of the battery cell stack and a second battery cell of the battery cell stack. The profiled equalizing element is deformable in this case in the event of an application of pressure of the profiled equalizing element in the stack direction. Furthermore, the housing has at least one compensation volume designed to absorb an expansion of the profiled equalizing element caused by the pressure application transversely to the stack direction.

### SUMMARY

Proceeding from the known prior art, it is an object of the present invention to provide an improved battery module having prismatic battery cells.

Moreover, it is an object of the invention to provide a battery module having improved fluid cooling.

The object is achieved by a battery module having the features of Claim 1. Advantageous refinements result from the dependent claims, the description and the figures.

The battery module comprises a first prismatic battery cell, a second prismatic battery cell and a profile. A cross section of the profile, in a non-loaded state of the profile, comprises a repeated sequence of a first essentially planar segment for contact on the first battery cell, a first elastic segment connected to the first essentially planar segment, a second essentially planar segment for contact with the second battery cell, which is connected to the first elastic segment, and a second elastic segment connected to the second essentially planar segment. In an installed state, the profile is arranged between the first and the second prismatic battery cell.

The profile can be a profile part. The profile can for example be a component produced by extrusion. In other words, the profile can be a component which has a uniform cross section in a depth direction of the profile over a depth of the profile, for example over an extrusion length of the profile.

The repeated sequence of the segments can for example be a repeated sequence of the described segments. The segments within the sequence can be connected to one another, so that the cross section of the profile can correspond, for example, to a simple curve without self-intersections. The profile can thus comprise a plurality of first essentially planar elements, a plurality of second essentially planar elements, and a plurality of elastic elements. A person skilled in the art readily recognizes here that the sequence can be terminated at one end of the profile and the cross section does not necessarily comprise integer multiples of the sequence. In other words, the profile can begin, for example, with a first essentially planar segment and end with a second essentially planar segment. A yielding profile for absorbing volume changes of the prismatic battery cells can thus be provided. For example, the profile can thus have a lower stiffness, which permits it to adapt to deformations of the battery cells.

The elastic segments can have, for example, a reduced stiffness in comparison to a rod-shaped or plate-shaped connection due to the cross-sectional geometry. They can be subjected to bending upon compression of the profile by the prismatic battery cells, for example. They can act as spring segments between the essentially planar segments. The elastic segments can be configured to be pre-tensioned in the installed state.

The non-loaded state of the profile can be a state of the profile in which the profile is only subjected to its weight force. In the non-loaded state, the profile thus may not be deformed.

Each of the first essentially planar segments can have an essentially planar outer surface, for example a planar outer surface, in the non-loaded state of the profile. A normal vector of the outer surfaces of the first essentially planar segments can be oriented in the direction of the first prismatic battery cell. The outer surfaces of the first essentially planar segments can be configured to contact the first prismatic battery cell, i.e. to form a contact surface with an outer side of the first prismatic battery cell.

Each of the second essentially planar segments can have an essentially planar outer surface, for example a planar outer surface, in the non-loaded state of the profile. A normal vector of the outer surfaces of the second essentially planar segments can be oriented in the direction of the second battery cell. The outer surfaces of the second essentially planar segments can be configured to contact the second prismatic battery cell, i.e. to form a contact surface with an outer side of the second prismatic battery cell.

The contact surfaces can be surfaces on each of which one of the prismatic battery cells touches one of the essentially planar segments. The surfaces can be essentially planar in the installed state. They can deform for example in operation of the battery module, so that they no longer have to be essentially planar in operation at local bulges.

Prismatic battery cells typically adopt a bulged profile upon swelling, thus then have a greater thickness in their middle areas of the respective cell walls than in the upper and lower areas. This also has to do with the fact that the cell walls in the middle areas are less well supported by the structural formation of the prismatic battery cells and therefore a deformation is more easily possible in the middle areas of the cell walls.

Due to the provision of the profile in the above-described manner, swelling of the prismatic battery cells which is pronounced by different strengths over the cell wall can accordingly be absorbed and/or equalized and a better adaptation to the battery cells can be enabled than, for example, if a stiffer intermediate frame is used.

The installed state is understood as a state in which the battery module comprises the first prismatic battery cell, the second prismatic battery cell, and the profile, and the profile is arranged abutting between the first and the second battery cell. In the installed state, the battery cells can be essentially non-deformed or can have a defined prismatic shape.

The profile and the first prismatic battery cell can form one or more fluid channels and the profile and the second prismatic battery cell can form one or more fluid channels.

The fluid channels are configured for guiding liquid, for example coolant liquid. The fluid channels can each be formed by the profile and one of the prismatic battery cells. In a cross section, a fluid channel can thus be bounded by two elastic segments, an essentially planar segment and an outer surface of one of the battery cells.

The fluid channels enable coolant liquid to deliberately flow past the cell walls of the prismatic battery cells so that improved cooling performance can be achieved.

The battery module can be configured so that liquid in a fluid channel has direct contact with precisely one cell wall of the prismatic battery cells, but on the opposite cell wall, the coolant liquid does not come directly into contact with the cell wall due to the segment of the profile abutting the cell wall. In other words, the profile can be constructed so that each cooling channel has at least one opening in the direction of one of the prismatic battery cells, and the opening is configured to provide contact between coolant liquid and prismatic battery cell. A cooling performance of the immersion cooling can thus be individualized for each battery cell.

In other words, only the profile is arranged between the prismatic battery cells and, for example, a plate and/or an intermediate frame is not arranged between one of the prismatic battery cells and the profile. The heat transfer can thus take place directly between the outer surfaces of the prismatic battery cells and the liquid.

The elastic segments can be arcuate segments. The arcuate segments can thus be arcuate independently of an external force.

The arcuate segments can be arcuate in the non-loaded state of the profile. The arcuate segments can be curved at least in some sections. Each arcuate segment can be completely curved or can be constructed from curved sections connected by essentially straight sections. Each arcuate segment can be respectively completely curved, i.e. the arcuate segment has a curvature at every point of a path line of the arcuate segment. The curvature can be, for example, a second derivative of the path line of the arcuate segment.

A length change of the profile upon compression by the prismatic battery cells can be reduced or avoided by the arcuate segments, since the arcuate segments compensate for the compression forces by an increased curvature due to their structural elasticity.

The arcuate segments can each have an essentially convex side and an essentially concave side. In each case an essentially convex and an essentially concave side of adjacent elastic segments can bound a fluid channel. In other words, a fluid channel can be bounded, for example, on its upper side in the installed state by a convex side of a first elastic segment and on its lower side in the installed state by a concave side of a second elastic segment.

All essentially concave sides can be oriented in a first direction of the battery module, and all essentially convex sides can be oriented in an opposing second direction of the battery module. The orientation of the concave sides can correspond, for example, to a direction of normal vectors of the concave side in a middle area of the concave sides, and the orientation of the convex sides can correspond, for example, to a direction of normal vectors of the convex side in a middle area of the convex side.

Due to the disclosed arrangement of in each case one convex and one concave side around a common fluid channel, a cross-sectional area ratio of adjacent fluid channels can remain equal or vary less in relation to one another upon compression of the profile than with flexible elements of battery modules from the prior art. A more homogeneous liquid flow can thus be enabled and mutual touching or blocking of the arcuate segments can be avoided or reduced.

Furthermore, an adaptation of the profile to uneven and/or bulged swelling of the prismatic battery cells can thus be improved.

For example, the cross sections of the arcuate segments in the profile can be essentially shifted in parallel in relation to one another.

The fluid channels can be configured for immersion cooling of the prismatic battery cells. For example, the fluid channels can be connected to a system of the battery module for supplying coolant liquid for immersion cooling of the first and second prismatic battery cell.

A better heat exchange can thus be enabled and the battery module can be operated at higher charging currents.

A ratio of a width of a fluid channel and a length of an essentially planar segment that bounds the fluid channel can be equal for at least two adjacent fluid channels. For example, the ratio can be equal for all fluid channels.

A length change of the profile upon compression can thus especially be reduced.

The profile can be embodied in one piece. In other words, the profile can be manufactured from one piece, for example extruded.

The profile can thus be manufactured more easily. In addition, better properties can thus be achieved upon the deformation by compression by the prismatic battery cells since the profile can have more homogeneous properties than a multipart assembly.

The profile can comprise a polymer. The polymer can be an oil-resistant polymer. For example, the profile can be produced from the polymer.

The use of a polymer can facilitate the manufacturing of the profile and reduce a stiffness of the profile, which can improve equalization of inhomogeneous expansion of the prismatic battery cells.

The polymer can be a polyimide. The polyimide can for example be a polyamide imide (PAI). Polyimides, for example polyamide imides, can contribute to pressure normalization across the profile due to their setting behaviour upon uneven deformation of the profile by the prismatic battery cells, so that, in the event of uneven swelling of the prismatic battery cells, a more uniform pressure can be applied to the battery cells.

The profile can have at least one rigid spacer, which in the installed state maintains a predetermined distance between areas of the prismatic battery cells abutting the spacer.

Assembly of the battery module can be simplified by the spacer, since all battery cells can maintain a predefined distance from one another by means of the spacer, which also does not vary due to elasticities. More precise pre-tensioning of the battery cells in relation to one another can thus be achieved and therefore a further-improved effect against occurring swelling of the cell walls can also be achieved. For example, a defined counterpressure can be achieved, since the counterpressure applied by means of the spring stiffness of the profile to the cell walls is clearly defined by the spacer and therefore is independent of possible inaccuracies in the assembly or the layering of the battery cells.

The spacer can be formed in one piece with the profile. One of the spacers can terminate an upper area of the profile and/or one of the spacers can terminate a lower area of the profile.

The profile can provide a varying spring stiffness over its extension, so that a varying counterpressure can also be provided over the extension of the respective abutting cell wall of the prismatic battery cell. The profile can have a higher spring stiffness in its middle area than in its upper area and/or its lower area.

It is therefore possible to provide a counterpressure distribution which counteracts swelling of a cell wall in a complementary manner. For example in areas of the cell wall in which stronger swelling occurs or such stronger swelling is expected, a higher counterpressure can also be provided via the profile, which then counteracts the increased swelling. The counterpressure distribution can be adapted accordingly by the spring stiffness varying over the extension of the profile to the conditions of the respective installed cell type and its individual swelling behaviour. The performance and longevity of the battery module can thus be further improved.

The varying spring stiffness can be achieved here, for example, by a varying geometry of the profile and/or varying wall thicknesses of the profile.

The above-mentioned object is furthermore achieved by a motor vehicle having the features of Claim 17.

The motor vehicle can comprise an electric drive system, at least one battery module of the above-described type, and a system for supplying coolant liquid for cooling the at least one battery module.

A motor vehicle can thus be provided which is suitable for charging at higher charging currents and therefore can require a shorter charging time for charging the at least one battery module.

### BRIEF DESCRIPTION OF THE DRAWINGS

Exemplary further embodiments of the invention are explained in more detail by the following description of the figures. In the figures:

FIG. 1 shows a perspective view of a battery module having two prismatic battery cells and a profile arranged between them;

FIG. 2 shows a side view of the battery module;

FIG. 3 shows a detail of the side view of the battery module from FIG. 2;

FIG. 4 shows a cross section of a section of the profile;

FIG. 5a shows a perspective view of the profile and one of the prismatic battery cells;

FIG. 5b shows a perspective view of the profile;

FIG. 6 shows a cross section of a further profile;

FIG. 7 shows a schematic side view of a battery module having the profile from FIG. 6; and

FIG. 8 shows a schematic representation of a section of a profile having a spacer.

### DETAILED DESCRIPTION

Preferred exemplary embodiments are described hereinafter on the basis of the figures. Identical, similar or identically acting elements are provided in the different figures with identical reference signs, and a repeated description of these elements is sometimes omitted to avoid redundancies.

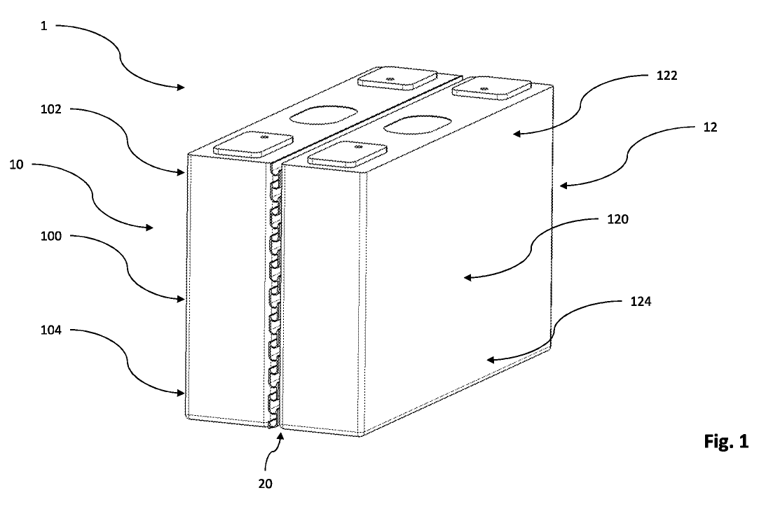

FIG. 1 is a perspective representation of a battery module 1. For the sake of improved comprehensibility, an outer housing of the battery module 1 is not shown in the figures.

The battery module in FIG. 1 comprises a first prismatic battery cell 10 and a second prismatic battery cell 12. The battery cells 10, 12 are prismatic lithium-ion battery cells in the example of FIG. 1.

These prismatic battery cells 10, 12 tend toward volume changes during charging and discharging due to the electrochemical processes in the cell. In addition, volume changes of the prismatic battery cells 10, 12 can occur in a thermally related manner. For example, the prismatic battery cells 10, 12 can expand so that deformations of outer surfaces of the battery cells occur. This expansion is also referred to as swelling. The expansion can take place unevenly, so that individual areas of the prismatic battery cells 10, 12 “bulge out”.

The expansion of the prismatic battery cells 10, 12 takes place in a particularly pronounced manner in the middle areas of the cell walls, in which the structural support by the upper and lower sides of the prismatic battery cells 10, 12 comes to bear less than in the upper and lower areas of the cell walls. The middle areas of the cell walls are schematically indicated by the reference signs 100, 120 in FIG. 1. The upper areas are schematically indicated by the reference signs 102, 122 and the lower areas by the reference signs 104, 124.

The expansion of the prismatic battery cells 10, 12 typically has the result that a prismatic battery cell having strong swelling has a quasi-cushion-shaped structure.

For this reason, equalizing elements, so-called swelling pads, are inserted between prismatic battery cells in the prior art. These compensate for the expansion of the prismatic battery cells and at the same time ensure a counterpressure which supports back-deformation of the battery cells, maintains the performance of the battery cells, and prevents bursting of the battery cells. However, it is generally not possible if swelling pads are used to cool the battery cells via the intermediate spaces between adjacent prismatic battery cells 10, 12, since the swelling pads are arranged in these intermediate spaces.

The battery module 1 proposed here therefore comprises a profile 20, which is arranged between the first battery cell 10 and the second battery cell 12. The profile 20 is elastically deformable and can thus compensate for the swelling similarly to a swelling pad.

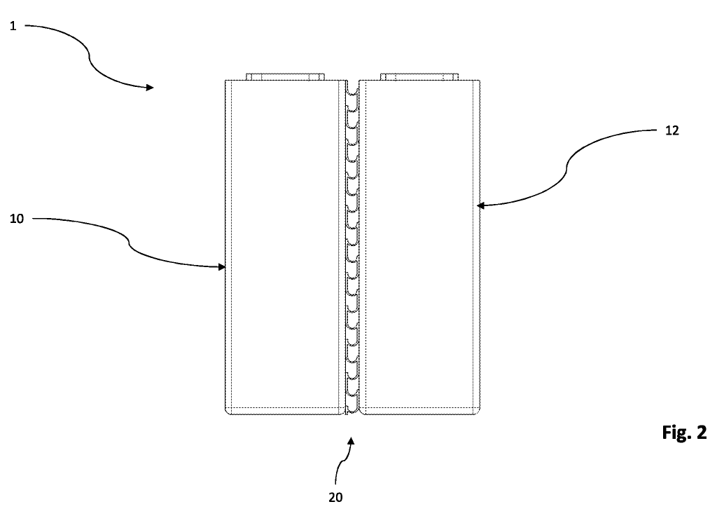

The profile 20 additionally comprises a plurality of fluid channels 36a, 36b, which enable fluid cooling, for example immersion cooling, of the battery module. The geometry of the profile 20 and the fluid channels 36a, 36b will be explained in more detail hereinafter with reference to FIGS. 2-5b.

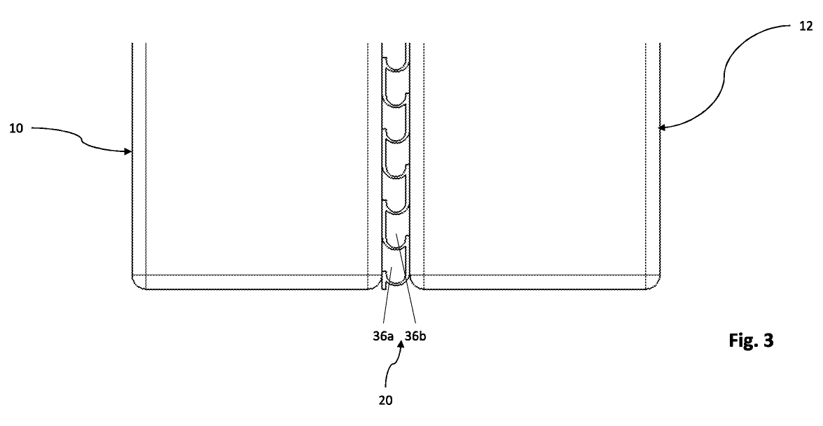

FIG. 2 is a side view of the battery module 1 from FIG. 1. FIG. 3 is an enlarged detail of the view of the battery module 1 from FIG. 2. In the example shown in the figures, the profile 20 is a profile, the cross section of which remains essentially uniform over a depth of the profile (i.e. perpendicular to the plane of the drawing in FIGS. 2-4). The profile 20 can be, for example, an extrusion profile.

As is apparent from FIG. 3, the profile 20 forms a plurality of fluid channels 36a, 36b together with the first battery cell 10 and the second battery cell 12. The fluid channels extend in the example of the figures parallel to opposing outer surfaces of the first prismatic battery cell 10 and the second prismatic battery cell 12.

A wall of the respective fluid channel 36a, 36b is formed here by the wall of a battery cell 10, 12, so that a fluid flowing through the respective fluid channel 36a, 36b is directly in contact with this wall of the battery cell. Particularly effective temperature control of the battery cells 10, 12 can thus be achieved.

The wall areas of the battery cells directly in contact with the respective fluid channels 36a, 36b are formed alternating over the height of the battery cells, so that a first fluid channel 36a comprises the wall of the first battery cell 10 and the fluid channel 36b located directly above it comprises the wall of the second battery cell 12.

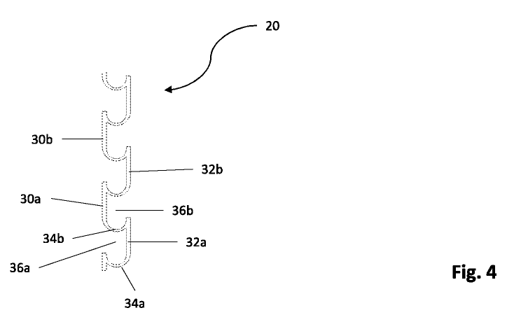

FIG. 4 shows the section of the profile 20 corresponding to the illustration in FIG. 3, in a non-loaded state and without the prismatic battery cells 10, 12 abutting the profile 20.

The profile 20 comprises a sequence of a first essentially planar segment 30a, 30b, a first arcuate segment 34a, a second essentially planar segment 32a, 32b, and a second arcuate segment 34b. The first essentially planar segment 30a, 30b is configured to contact the first prismatic battery cell 10. The second essentially planar segment 32a, 32b is configured to contact the second prismatic battery cell 12. In other words, the first and the second planar segments are on opposite sides of the profile 20 so that they can each abut the battery cells.

The arcuate segments 34a, 34b in the example of FIG. 4 each have an identical shape and are shifted in parallel to one another. However, the arcuate elements can also have shapes deviating from one another, thus adjacent arcuate elements of the profile can be mirrored, for example, with respect to one another at a vertical axis of the profile 20 (not shown in FIG. 4).

The arcuate segments 34a, 34b form an elastic structure and can deform and preferably also form a pre-tension corresponding to the deformation.

The profile 20 is configured by its geometry to deform upon compression. For example, the arcuate segments 34a, 34b can deflect further. For example, the arcuate segments 34a, 34b can thus be used as elastic elements. A lower stiffness and therefore a greater flexibility than, for example, upon the use of trapezoid plates is achieved by the geometry, so that it is possible to react better to uneven or bulging swelling of the battery cells 10, 12.

The arcuate segments 34a, 34b each have an essentially convex side and an essentially concave side. In the example shown in the figures, a convex side of an arcuate segment is opposite in each case to a concave side of an adjacent arcuate segment. In other words, in FIG. 4, each fluid channel 36a, 36b within the profile is bounded either by a concave side of an arcuate segment 34a, a convex side of an arcuate segment 34b, a first essentially planar segment 30a, 30b, and an outer surface of the second prismatic battery cell 12, or by a concave side of an arcuate segment 34a, a convex side of an arcuate segment 34b, a second essentially planar segment 32a, 32b, and an outer surface of the first prismatic battery cell 10.

With uniform compression of the profile 20 by the battery cells 10, 12, the fluid channels 36a, 36b thus have an essentially equal cross-sectional ratio with respect to the non-loaded state. A more homogeneous liquid flow through the fluid channels 36a, 36b can thus be enabled. In addition, upon compression, contact between adjacent arcuate segments 34a, 34b or mutual blocking is avoided or at least reduced.

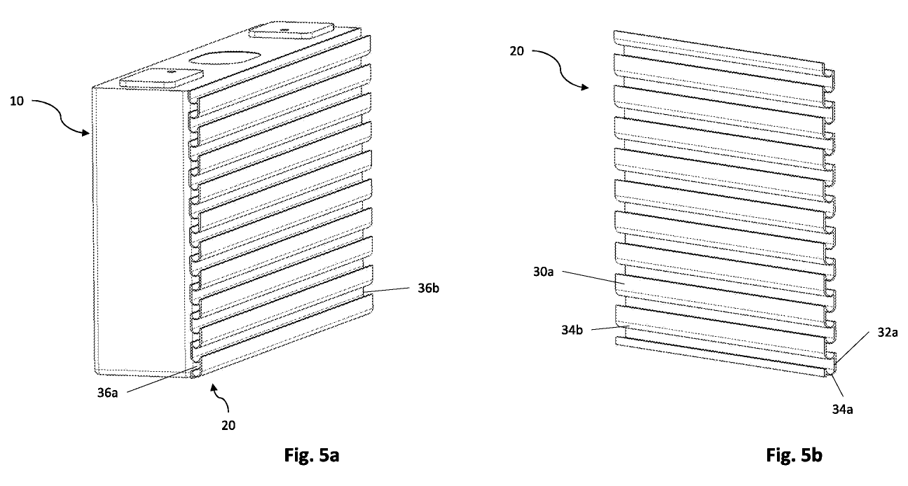

FIG. 5a shows a perspective view of the first prismatic battery cell 10 and the profile 20. The profile 20 corresponds to the profile from FIGS. 1-4, so that fluid channels 36a, 36b are formed as described above between the profile and the first prismatic battery cell 10. As can be seen, the fluid channels 36a, 36b enable contact between the liquid and an outer surface of the prismatic battery cell 10, so that better cooling properties can be achieved.

FIG. 5b shows a perspective view of the profile 20. In FIG. 5b, as in FIG. 4, a first essentially planar segment 30a, a second essentially planar segment 32a, and arcuate segments 34a, 34b are visible.

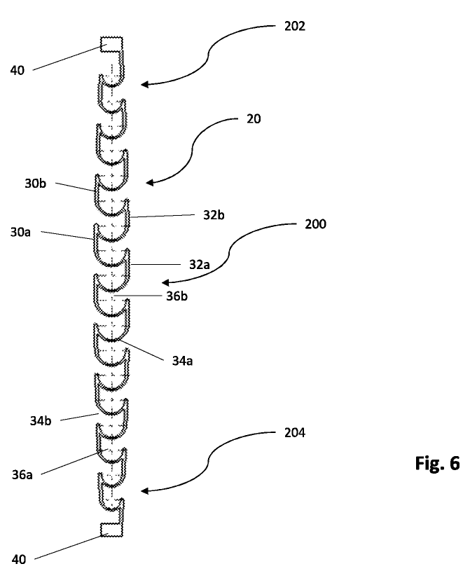

FIG. 6 shows a further profile 20 of a further embodiment. This profile has a spacer 40 in each case in its upper area 202 and its lower area 204. The spacers 40 are rigid in relation to the areas of the profile 20 located therebetween and form a stop for the battery cells 10, 12, on each of which they can abut.

The spacers 40 can be formed in one piece with the remaining profile 20.

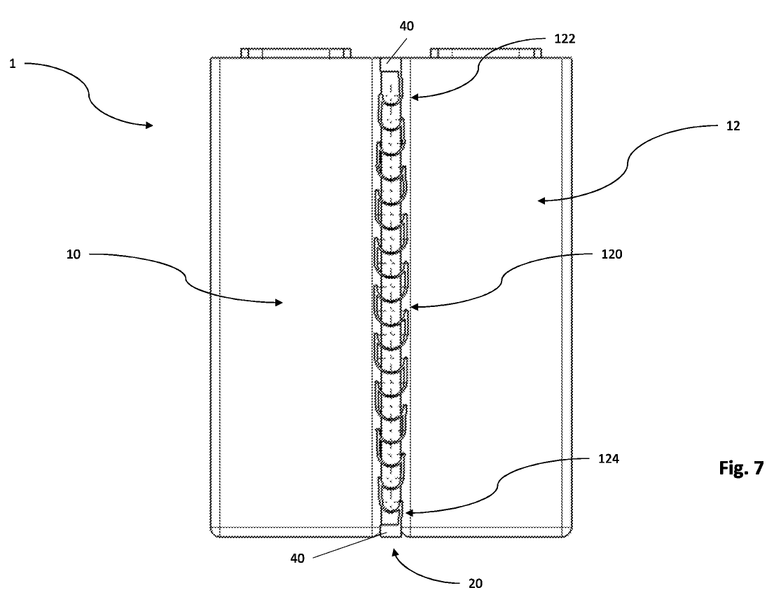

This contact of the battery cells 10, 12 on the two spacers 40 of the profile 20 is schematically shown in FIG. 7.

During the installation of the battery cells 10, 12 within the battery module 1, due to the spacers 40, it is possible to achieve that the battery cells 10, 12 have a defined and fixed distance from one another in their respective essentially rigid upper and lower areas. This enhances the precision in the installation and enables a defined pre-tension of the battery cells 10, 12 in relation to one another, also with the profile 20 interconnected in the other areas of the battery cells 10, 12.

Furthermore, during the bracing of the battery cells 10, 12 against one another during the installation, a tightened screw connection can also be achieved if a screw clamp encompassing all battery cells is used to clamp the battery cells 10, 12 against one another.

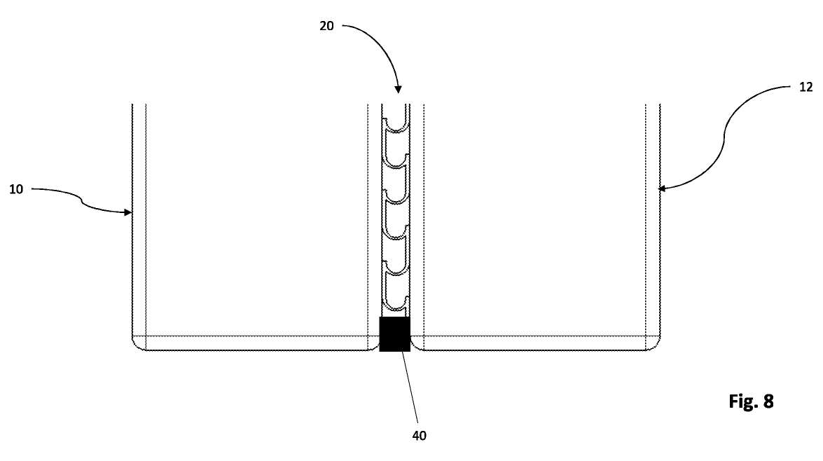

The use of a spacer 40 in combination with the profile 20 from FIG. 4 is also schematically shown once again in FIG. 8.

The profile of FIG. 6 furthermore differs from the profile shown in FIGS. 1-5b in that it has different dimensions over its entire extension and it is wider in its middle area 200 in the cross-sectional view shown here than in its upper area 202 and its lower area 204.

Different spring stiffnesses are thus achieved over the vertical extension of the profile 20, so that a counterpressure distribution of the installed profile 20 varying over the vertical extension is also achieved.

In this way, the profile 20 can provide a pressure distribution which counteracts the expansion behaviour in a complementary manner over the height of the battery cells 10, 12. In other words, a lower counterpressure is provided by the profile 20 in the upper area 202 of the profile 20 than in the middle area 200 of the profile 20. Likewise, a lower counterpressure is provided by the profile 20 in the lower area 204 of the profile 20 than in the middle area 200 of the profile 20.

This counterpressure distribution counteracts the stronger swelling of the prismatic battery cells 12 in the middle area 120 more strongly than in the upper area 122 or the lower area 124, as schematically shown in FIG. 7. The performance of the battery cells 10, 12 can be enhanced further by the counterpressure adapted over the areas of the cell wall of the battery cell and provided by the profile 20, because the deformations of the cell walls can be compensated for even better and more deliberately.

In FIG. 6, the varying counterpressure distribution of the profile 20 is achieved by the geometric embodiment of the profile 20 between the two spacers 40. In the middle area 200 of the profile 20, the profile 20 has a greater lateral extension than in its upper area 202 and its lower area 204. Due to this geometric design, the adaptation of the counterpressure distribution can be achieved such that the counterpressure exerted on the respective abutting cell walls is greater in the middle area 200 than in the other areas.

In an alternative or addition (not shown), the varying counterpressure distribution can also be achieved in that the wall thicknesses of the profile vary over its vertical extension so that the desired variation of the spring stiffness and therefore the adaptation of the counterpressure distribution is achieved.

In still another alternative or addition (not shown here), the individual segments of the profile can also be embodied having different geometries over the vertical extension in order to achieve the desired varying counterpressure distribution. For example, the arcuate segments can be arranged closer to one another in the middle area 200 of the profile 20, so that a higher spring stiffness is achieved here.

If applicable, all individual features shown in the exemplary embodiments can be combined and/or exchanged with one another without departing from the field of the disclosure.

### LIST OF REFERENCE SIGNS

1 battery module

10 first prismatic battery cell

100 middle area of the cell wall of the first prismatic battery cell

102 upper area of the cell wall of the first prismatic battery cell

104 lower area of the cell wall of the first prismatic battery cell

12 second prismatic battery cell

120 middle area of the cell wall of the second prismatic battery cell

122 upper area of the cell wall of the second prismatic battery cell

124 lower area of the cell wall of the second prismatic battery cell

20 profile

200 middle area of the profile

202 upper area of the profile

204 lower area of the profile

30a, 30b first essentially planar segment

32a, 32b second essentially planar segment

34a, 34b arcuate segment

36a, 36b fluid channel

40 spacer

1. A battery module comprising a first prismatic battery cell, a second prismatic battery cell and a profile, wherein a cross section of the profile in a non-loaded state of the profile comprises a repeated sequence of
(i) a first essentially planar segment for contact on the first battery cell,
(ii) a first elastic segment, which is connected to the first essentially planar segment,
(iii) a second essentially planar segment for contact on the second battery cell, which is connected to the first elastic segment, and
(iv) a second elastic segment, which is connected to the second essentially planar segment,
and wherein the profile is arranged in an installed state between the first and the second prismatic battery cell.

2. The battery module according to claim 1, wherein the profile and the first prismatic battery cell form one or more fluid channels (and the profile and the second prismatic battery cell form one or more fluid channels,
wherein the fluid channels are configured to be sealed in relation to one another and are configured to separate a liquid in a fluid channel from a liquid in adjacent fluid channels.

3. The battery module according to claim 2, wherein at least one fluid channel is formed so that a liquid guided in this fluid channel has direct contact with one of the prismatic battery cells.

4. The battery module according to claim 3, wherein the elastic segments are arcuate segments.

5. The battery module according claim 4, wherein the elastic segments each have an essentially convex side and an essentially concave side,
wherein in each case an essentially convex side of an elastic segment and an essentially concave side of an adjacent elastic segment bound a common fluid channel.

6. The battery module according to claim 2, wherein the fluid channels are configured for immersion cooling of the prismatic battery cells,
wherein the fluid channels are configured to be connected to a system of the battery module to supply coolant liquid for immersion cooling of the first and second prismatic battery cell.

7. The battery module according to claim 2, wherein a ratio of a width of a fluid channel and a length of an essentially planar segment, which bounds the fluid channel, is equal for at least two adjacent fluid channels.

8. The battery module according to claim 1, wherein the profile is embodied in one piece.

9. The Battery module according to claim 1, wherein the profile comprises or is formed from an oil-resistant polymer.

10. The battery module according to claim 9, wherein the polymer is a polyamide imide.

11. The battery module according to claim 1, wherein the profile has at least one rigid spacer, which in the installed state maintains a predetermined distance between areas of the prismatic battery cells abutting the spacer.

12. The battery module according to claim 11, wherein the spacer is formed in one piece with the profile.

13. The battery module according to claim 11, wherein at least one of: a spacer terminates an upper area of the profile; and a spacer terminates a lower area of the profile.

14. The battery module according to claim 1, wherein the profile provides a varying spring stiffness over its extension.

15. The battery module according to claim 14, wherein the profile has a higher spring stiffness in its middle area than in at least one of: its upper area and its lower area.

16. The battery module according to claim 14, wherein the varying spring stiffness is achieved by at least one of: a varying geometry of the profile and a varying wall thicknesses of the profile.

17. A motor vehicle, comprising an electric drive system, at least one battery module, and a system for supplying coolant liquid for cooling the at least one battery module,
wherein the battery module comprises a first prismatic battery cell, a second prismatic battery cell and a profile, wherein a cross section of the profile in a non-loaded state of the profile comprises a repeated sequence of
(i) a first essentially planar segment for contact on the first battery cell,
(ii) a first elastic segment, which is connected to the first essentially planar segment,
(iii) a second essentially planar segment for contact on the second battery cell, which is connected to the first elastic segment, and
(iv) a second elastic segment, which is connected to the second essentially planar segment,
and wherein the profile is arranged in an installed state between the first and the second prismatic battery cell.
